(19) United States
(12) Patent Application Publication
(10) Pub. No.: US 2015/0267875 A1
(43) Pub. Date: Sep. 24, 2015

(54) LED True Full Spectrum

(71) Applicant: Rodney L. Bates, Mountain House, CA (US)

(72) Inventor: Rodney L. Bates, Mountain House, CA (US)

(21) Appl. No.: 14/222,546

(22) Filed: Mar. 21, 2014

(51) Int. Cl. F21K 99/00

(52) U.S. Cl. CPC F21K 9/30; F21Y 2113/005

(57) ABSTRACT

Light Emitting Diodes (LEDs) are tiny light bulbs commonly used in flashlights today. The phrase “Full Spectrum” refers to the visible colors of the rainbow: purple, blue, green, yellow, orange, red and all shades in between. The so-called “Full Spectrum” LED light fixtures, lamps, etc. available today are not really full spectrum. The white LEDs in these lights have a serious lack of cyan (light blue). All the other colors are 4 times brighter than cyan. This deficiency is remedied by using 1 cyan LED for every 7 white LEDs. After blending the light with a lens, the result is a true rainbow of colors.

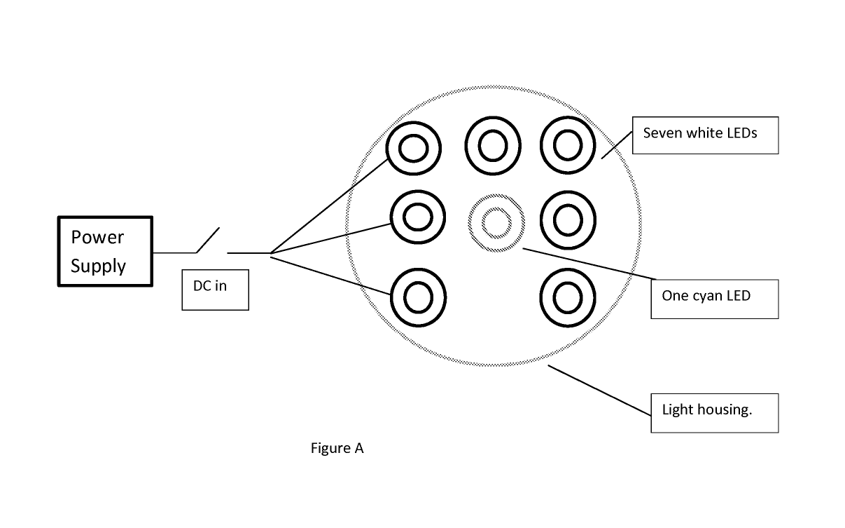

### TECHNICAL FIELD AND INDUSTRIAL APPLICABILITY OF THE INVENTION

This invention relates to creating a true full spectrum light by utilizing eight Light Emitting Diodes (LEDs). Multiple sets of eight LEDs may be used for greater illumination. The resulting full spectrum light is measured as scientifically accurate.

### BACKGROUND OF THE INVENTION

Light Emitting Diodes (LEDs) have been used for engineering and scientific purposes since 1962. During the 1990's wide-spread commercial and consumer use of LEDs began.

Commercial and consumer applications for LEDs can require the generation of a full spectrum of colors from one LED fixture.

The “white” LED does not produce a full spectrum of color. The wavelengths from 440 nanometers to 475 nanometers have an average relative intensity of 0.4. The range of light from 475 to 525 nanometers has an average relative intensity of 0.1. The wavelengths from 525 nanometers to 625 nanometers have an average relative intensity of 0.4. Therefore, the white LED has a deficiency in the wavelengths from 475 to 525 nanometers.

The range is filled by using a cyan LED at the ratio of seven white LEDs to one cyan LED. The cyan LED emits light at 505 nanometers. The cyan LED fills the visible spectrum to produce true full spectrum light. The mixture of LEDs can be accomplished in many ways. The simplest way is to have an array of seven white LEDs and one cyan LED. Multiple arrays of LEDs can be used when a greater amount of light is required. Brighter LEDs can be used when a greater amount of light is required. Dimmer LEDs can be used when a lesser amount of light is required. The colors are blended with a lens to produce a true full spectrum of visible light.

### SPECIFICATION OF THE INVENTION

### Description

This invention consists of a circuit that performs the function of illuminating one or more sets of eight LEDs to produce a true full spectrum of visible light. The spectrum can be measured in nanometers.

Parts and Functionality (see Figure A):
a. Power to the switch circuit is direct current.
b. Power is distributed evenly to all eight LEDs, when the switch is closed.
c. The LEDs are arranged in a grid, with the center LED being cyan.
d. Eight LEDs from each set of eight LEDs light up. The light is blended using a lens. The resultant blended light is a complete visible spectrum.
e. The eight required LEDs are as follows:
   One cyan, 505 nanometers,
   Seven white.

Best way to practice the invention: build a circuit comprising a DC power supply, switch, wires, light housing, white LEDs and cyan LEDs of approximately the same wattage.

Although the present invention has been described with reference to preferred embodiments, numerous modifications and variations can be made and still fall within the scope of the invention.

Increasing or decreasing the scale of the preferred embodiment and/or increasing the number of instances of the embodiment will still fall within the scope of the invention

### BRIEF DESCRIPTION OF DRAWING

Figure A is the LED True Full Spectrum schematic, showing the best way to practice the invention. The power supply is direct current. A switch is provided to either send electricity to the circuit or to interrupt power to the circuit. The seven white LEDs and one cyan LED are held by the housing. Wires are connected to the back of the housing so that the electricity arrives at the LEDs. This will cause all of the LEDs to light up. The result is a full spectrum of visible light.

1. LED True Full Spectrum is achieved by constructing a lighting circuit comprising:
a. One or more cyan LEDs, 505 nanometers,
b. One or more sets of so-called “white” LEDs,
c. The ratio of cyan LEDs to “white” LEDs must create a full spectrum of visible light, which is entitled “LED True Full Spectrum” light.

2. Based on the LED True Full Spectrum from claim 1, when a greater amount of LED True Full Spectrum lighting is required, multiple sets of white LEDs and cyan LEDs are used.

3. Based on the LED True Full Spectrum from claim 1, when a lesser amount of LED True Full Spectrum lighting is required, smaller white LEDs and smaller cyan LEDs are used.

4. Based on the LED True Full Spectrum from claim 1, when a greater amount of LED True Full Spectrum lighting is required, greater direct current voltage is used.

5. Based on the LED True Full Spectrum from claim 1, when a lesser amount of LED True Full Spectrum lighting is required, lesser direct current voltage is used.

6. Based on the LED True Full Spectrum from claim 1, although the present invention has been described with reference to preferred embodiments, numerous modifications and variations can be made and still fall within the scope of the invention.

7. Based on the LED True Full Spectrum from claim 1, increasing or decreasing the scale of the preferred embodiment and/or increasing the number of instances of the embodiment will still fall within the scope of the invention
